(19) United States
(12) Patent Application Publication
(10) Pub. No.: US 2020/0139956 A1
(43) Pub. Date: May 7, 2020

(54) HYBRID VEHICLE

(71) Applicant: Toyota Jidosha Kabushiki Kaisha, Toyota-shi Aichi-ken (JP)

(72) Inventor: Koichiro Muta, Okazaki-shi Aichi-ken (JP)

(73) Assignee: Toyota Jidosha Kabushiki Kaisha, Toyota-shi Aichi-ken (JP)

(21) Appl. No.: 16/671,950

(22) Filed: Nov. 1, 2019

(30) Foreign Application Priority Data
Nov. 5, 2018 (JP) 2018-208114

(51) Int. Cl. B60W 20/10; B60K 6/24; B60W 10/06; B60W 10/08; F01N 3/021; B01D 46/44

(52) U.S. Cl. CPC B60W 20/10; B60K 6/24; B60W 10/06; B60W 10/08; F01N 3/021; B01D 46/448; B01D 2279/30; B60W 2710/086; B60W 2510/068; B60W 2510/0676; B60W 2540/10; B60W 2510/0638; B60W 2710/0677

(57) ABSTRACT

A filter temperature rising control is performed to set a target power of the engine within a range larger than a traveling power needed to travel and control an engine and a motor to travel based on the traveling power with output of the target power from the engine and power generation by the motor, when temperature rise of the filter is requested. The target power is set based on at least one of traveling power and engine temperature, when the filter temperature rising control is performed.

### CROSS-REFERENCE TO RELATED APPLICATIONS

This application claims priority to Japanese Patent Application No. 2018-208114 filed on Nov. 5, 2018, which is incorporated herein by reference in its entirety including the specification, drawings and abstract.

### BACKGROUND

### 1. Technical Field

The present disclosure relates to a hybrid vehicle, and more particularly, to a hybrid vehicle including an engine in which a filter for removing particulate matter is attached to an exhaust system.

### 2. Description of Related Art

In the related art, a hybrid vehicle has been suggested that includes an engine in which a filter for exhaust gas control is attached to an exhaust system, a motor generator connected to the engine through clutch and a battery that exchanges an electric power with the motor generator (see, for example, Japanese Unexamined Patent Application Publication No. 2017-149233 (JP 2017-149233 A)). In the hybrid vehicle, when certain conditions are met where particulate matter deposited on the filter may be burned, the motor generator performs regenerative power generation and thus the engine load is increased, which makes the temperature of the exhaust gas flowing into the filter higher than the burning temperature that is needed to burn the particulate matter.

### SUMMARY

In the hybrid vehicle described above, when the temperature rise of the filter is promoted, the load on the engine is increased without considering the state of the engine. For this reason, it is likely that the amount of particulate matter flowing into the filter is excessively large.

The main object of a hybrid vehicle of the present disclosure is to provide a hybrid vehicle capable of suppressing an excessive increase in the amount of particulate matter flowing into a filter when temperature rise of the filter is promoted.

The hybrid vehicle of the present disclosure employs the following to achieve the main object described above.

An aspect of the present disclosure relates to a hybrid vehicle. The hybrid vehicle includes an engine, a motor, a power storage device and a control device. In the engine, a filter for removing particulate matter is attached to an exhaust system. The motor is connected to an output shaft of the engine. The power storage device exchanges an electric power with the motor. The control device performs filter temperature rising control that sets a target power of the engine within a range larger than a traveling power needed to travel and controls the engine and the motor to travel based on the traveling power with output of the target power from the engine and power generation by the motor, when temperature rise of the filter is requested. In addition, the control device is configured to set the target power based on at least one of a temperature of the engine and the traveling power, when the filter temperature rising control is performed.

With the hybrid vehicle according to the aspect, the filter temperature rising control is performed that sets the target power of the engine within the range larger than the traveling power needed to travel when the temperature rise of the filter is requested, and controls the engine and the motor to travel based on the traveling power with output of the target power from the engine and power generation by the motor, when temperature rise of the filter is requested. When the filter temperature rising control is performed, the target power is set based on at least one of the traveling power and the temperature of the engine. Therefore, when an appropriate target power is set in consideration of the traveling power or the temperature of the engine when the filter temperature rising control is performed, it is possible to suppress the excessive increase in the amount of particulate matter flowing into the filter when the filter temperature rise is promoted.

In the hybrid vehicle according to the aspect, the control device may be configured to set the target power to be smaller when the temperature of the engine is lower than when the temperature of the engine is higher, when the filter temperature rising control is performed. As the temperature of the engine becomes lower, the fuel is less likely to vaporize, and the amount of particulate matter flowing into the filter tends to increase. Therefore, by setting the target power as described above, it is possible to suppress the excessive increase in the amount of particulate matter flowing into the filter.

In the hybrid vehicle according to the aspect, the control device may be configured to set the target power to be smaller when the traveling power is larger than when the traveling power is smaller, when the filter temperature rising control is performed. As the power from the engine becomes greater, more fuel is supplied to the engine, and the particulate matter flowing into the filter tends to increase. Therefore, by setting the target power as described above, it is possible to suppress the excessive increase in the amount of particulate matter flowing into the filter.

In the hybrid vehicle of the embodiment, the control device may be configured to perform the filter temperature rising control when an accelerator is operated and not to perform the filter temperature rising control when the accelerator is not operated, when temperature rise of the filter is requested. In a case where the filter temperature rising control is performed when the accelerator is not operated, a certain amount of power is output from the engine at the time of the accelerator not being operated and the power storage device is charged, which may result in uncomfortable feeling of a driver. In contrast, the filter temperature rising control is not performed when the accelerator is not operated. In this way, it is possible to suppress the sense of discomfort which the driver may feel.

In the hybrid vehicle according to the aspect, the control device may be configured to control the engine such that the engine revolves at a predetermined engine speed or higher, when the filter temperature rising control is performed. With the hybrid vehicle according to the aspect, it is possible to secure a certain amount of air per unit time of the engine, that is, a certain amount of exhaust gas per unit time flowing into the filter can be secured even when the accelerator operation amount (target power) is low, which makes it possible to promote the temperature rise of the filter.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a configuration view schematically illustrating a configuration of a hybrid vehicle 20 according to an embodiment of the present disclosure;

FIG. 2 is a view illustrating an example of an operation line of an engine 22 and a mode of setting a target engine speed Ne* and a target torque Te*;

FIG. 3 is a flowchart showing an example of a charge/discharge request power routine executed by a hybrid vehicle electronic control unit (HVECU) 70;

FIG. 4 is a view illustrating an example of a map for a first charge/discharge request power setting;

FIG. 5 is a view illustrating an example of a map for a second charge/discharge request power setting; and

FIG. 6 is a configuration view schematically illustrating a configuration of a hybrid vehicle 120 according to a modification example.

### DETAILED DESCRIPTION OF EMBODIMENTS

Next, an embodiment for implementing the present disclosure will be described.

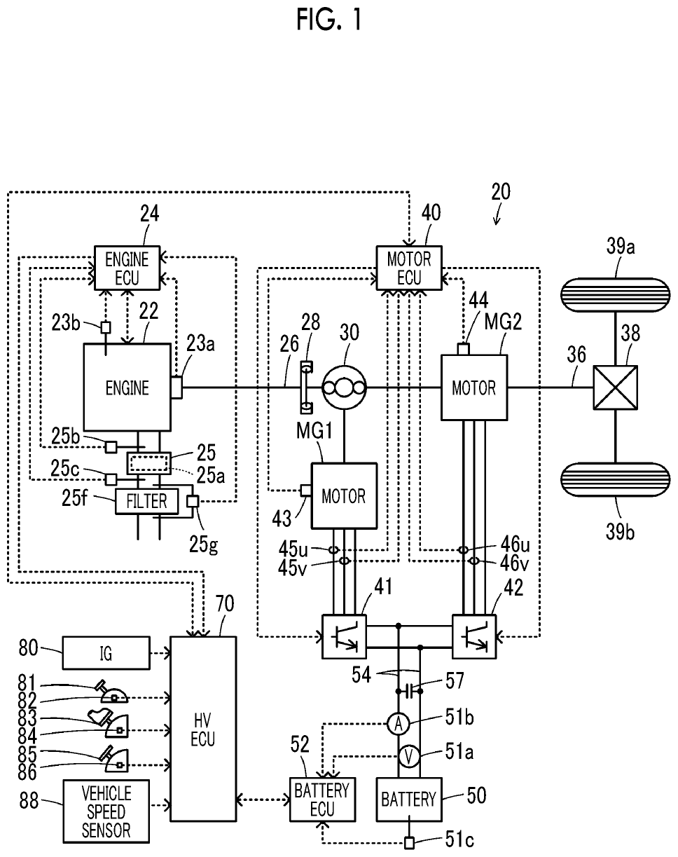

FIG. 1 is a configuration view schematically illustrating a configuration of a hybrid vehicle 20 according to an embodiment of the present disclosure. As illustrated in the figure, a hybrid vehicle 20 of the embodiment includes an engine 22, a planetary gear 30, motors MG1, MG2, inverters 41, 42, a battery 50 as a power storage device, and a hybrid vehicle electronic control unit (hereinafter referred to as “HVECU”) 70.

The engine 22 is an internal combustion engine that outputs power by using gasoline or diesel as a fuel, and is connected to a carrier of a planetary gear 30 through a damper 28. An exhaust gas control apparatus 25 and a particulate matter removal filter (hereinafter referred to as “PM filter”) 25f are attached to an exhaust system of the engine 22. The exhaust gas control apparatus 25 includes a catalyst 25a that removes unburned fuel and nitrogen oxides in the exhaust gas of the engine 22. The PM filter 25f is formed as a porous filter using ceramics, stainless steel, or the like, and captures particulate matter (PM) such as soot in the exhaust gas. The operation of the engine 22 is controlled by an engine electronic control unit (hereinafter referred to as “engine ECU”) 24.

Although not illustrated, the engine ECU 24 may include a microprocessor, mainly a central processing unit (CPU). In addition to the CPU, the engine ECU 24 includes a read only memory (ROM) that stores processing programs, a random access memory (RAM) that temporarily stores data, an input/output port, and a communication port. Signals from various sensors needed to control the operation of the engine 22 are input to the engine ECU 24 through an input port. Examples of signals input to the engine ECU 24 includes a crank angle θcr from a crank position sensor 23a detecting the rotational position of a crankshaft 26 of the engine 22, and the coolant temperature Tw from a coolant temperature sensor 23b detecting the temperature of the coolant of the engine 22. Further, an air-fuel ratio ΔP from an air-fuel ratio sensor 25b attached upstream of the exhaust gas control apparatus 25 in the exhaust system of the engine 22, and an oxygen signal O2 from an oxygen sensor 25c attached downstream of the exhaust gas control apparatus 25 in the exhaust system of the engine 22 may also be included in the examples. Furthermore, the differential pressure ΔP from the differential pressure sensor 25g detecting the differential pressure before and after the PM filter 25f (the differential pressure between the upstream side and the downstream side) may also be regarded as another example. Various control signals for controlling the operation of the engine 22 are output from the engine ECU 24 through an output port. The engine ECU 24 is connected to the HVECU 70 through the communication port.

The engine ECU 24 calculates the engine speed of the engine based on the crank angle θcr from the crank position sensor 23a, or calculates (estimates) the temperature Tc (catalyst temperature) of the catalyst 25a based on the coolant temperature Tw from the coolant temperature sensor 23b. In addition, the engine ECU 24 calculates a volumetric efficiency (ratio of the volume of air actually taken into the engine 22 in one cycle to the stroke volume in one cycle of the engine 22) KL based on the intake air amount Qa from an air flow meter (not shown) and the engine speed Ne of the engine 22. Furthermore, the engine ECU 24 calculates the deposition amount Qpm of PM as an deposition amount of particulate matter deposited on the PM filter 25f based on the differential pressure ΔP from the differential pressure sensor 25g, and calculates the filter temperature Tf as temperature of the PM filter 25f based on the engine speed Ne of the engine 22 and the volumetric efficiency KL.

The planetary gear 30 may be a single-pinion type planetary gear mechanism, and includes a sun gear, a ring gear, a plurality of pinion gears that mesh with the sun gear and the ring gear, and a carrier that rotatably and revolvably supports the pinion gears. The sun gear of the planetary gear 30 is connected to the rotor of a motor MG1. The ring gear of the planetary gear 30 is connected to a drive shaft 36 coupled to the drive wheels 39a, 39b through a differential gear 38. As described above, the crankshaft 26 of the engine 22 is connected to the carrier of the planetary gear 30 through the damper 28. Therefore, it can be said that the motor MG1, the engine 22, the drive shaft 36, and a motor MG2 are connected to the sun gear, the carrier, and the ring gear as three rotational elements of the planetary gear 30 such that the motor MG1, the engine 22, the drive shaft 36, and a motor MG2 are arranged in this order in a collinear diagram of the planetary gear 30.

The motor MG1 may be, for example, a synchronous generator motor, and the rotor is connected to the sun gear of the planetary gear 30 as described above. The motor MG2 may be, for example, a synchronous generator motor, and a rotor is connected to the drive shaft 36. Inverters 41, 42 are used in drive motors MG 1 and MG 2 and are connected to battery 50 through power lines 54. A smoothing capacitor 57 is attached to the power lines 54. The motors MG1, MG2 are rotationally driven by switching control of a plurality of switching elements (not shown) of the inverters 41, 42 by a motor electronic control unit (hereinafter referred to as “motor ECU”) 40.

Although not illustrated, the motor ECU 40 may include a microprocessor, mainly a central processing unit (CPU). In addition to the CPU, the motor ECU 40 includes a ROM that stores processing programs, a RAM that temporarily stores data, an input/output port, and a communication port. Signals from various sensors needed to control the driving of the motors MG1, MG2 are input to the motor ECU 40 through the input port. Here, the examples of the signals include rotational positions θm1, θm2 from the rotational position detecting sensors 43, 44 detecting rotational positions of the rotors of the motors MG1, MG2, and phase currents Iu1, Iv1, Iu2, Iv2 from current sensors 45u, 45v, 46u, 46v detecting currents flowing in the phases of the motors MG1, MG2. From the motor ECU 40, switching control signals of the switching elements of the inverters 41, 42 are output through the output port. The motor ECU 40 is connected to the HVECU 70 through the communication port. The motor ECU 40 calculates the electrical angles θe1, θe2, the angular velocities ωm1, ωm2, and the rotation speeds Nm1, Nm2 of the motors MG1, MG2, based on the rotational positions θm1, θm2 of the rotors of the motors MG1, MG2 from the rotational position detecting sensors 43, 44.

The battery 50 may be, for example, a lithium-ion secondary battery or a nickel hydride secondary battery, and is connected to the power lines 54. The battery 50 is managed by a battery electronic control unit (hereinafter referred to as “battery ECU”) 52.

Although not illustrated, the battery ECU 52 may include a microprocessor, mainly a CPU. In addition to the CPU, the battery ECU 52 includes a ROM that stores processing programs, a RAM that temporarily stores data, an input/output port, and a communication port. Signals from various sensors needed to manage the battery are input to the battery ECU 52 through the input port. Examples of signals input to the battery ECU 52 includes the voltage Vb of the battery 50 from a voltage sensor 51a attached between the terminals of the battery 50 or the current Ib of the battery 50 from a current sensor 51b attached to the output terminal of the battery 50, and the temperature Tb of the battery 50 from a temperature sensor 51i attached to the battery 50. The battery ECU 52 is connected to the HVECU 70 through the communication port. The battery ECU 52 calculates the power storage ratio (state of charge) SOC based on the integrated value of the current Ib of the battery 50 from the current sensor 51b, or calculates input/output limits Win and Wout of the battery 50 based on the calculated power storage ratio SOC and the temperature Tb of the battery 50 from the temperature sensor 51c. The power storage ratio SOC is the ratio of the amount of power that can be discharged from the battery 50 to the total capacity of the battery 50, and the input/output limits Win and Wout are allowable input/output power that may charge/discharge the battery 50.

Although not illustrated, the HVECU 70 may include a microprocessor, mainly a CPU. In addition to the CPU, the HVECU 70 includes a ROM that stores processing programs, a RAM that temporarily stores data, an input/output port, and a communication port. Signals from various sensors are input to the HVECU 70 through the input port. Examples of the signals input to the HVECU 70 include an ignition signal from an ignition switch 80 and a shift position SP from a shift position sensor 82 detecting the operation position of a shift lever 81. Further, the accelerator operation amount Ace from a accelerator pedal position sensor 84 detecting the depression amount of the accelerator pedal 83, the brake pedal position BP from a brake pedal position sensor 86 detecting the depression amount of the brake pedal 85, and the vehicle speed V from a vehicle speed sensor 88 can be also included by way of example. As described above, the HVECU 70 is connected to the engine ECU 24, the motor ECU 40, and the battery ECU 52 through the communication port.

The hybrid vehicle 20 of the embodiment configured as described above travels in a hybrid travel mode (HV travel mode) where traveling is performed with the engine 22 being rotated or an electric travel mode (EV travel mode) where traveling is performed with the rotating of the engine 22 being stopped.

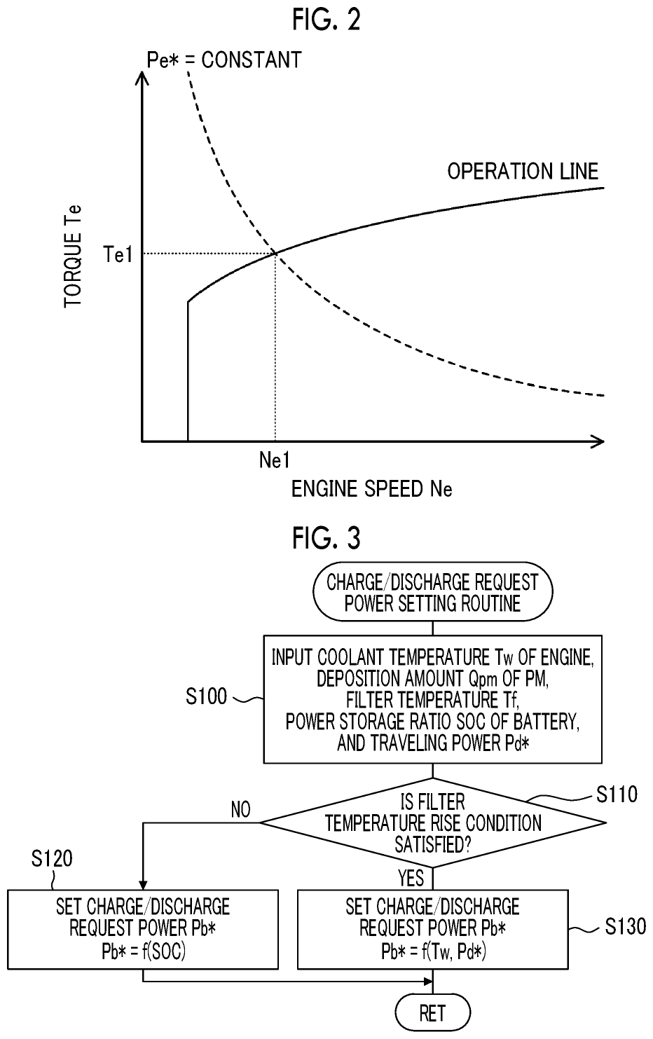

When the accelerator is operated in the HV travel mode, the HVECU 70 sets the traveling torque Td* needed to travel (needed for the drive shaft 36) based on the accelerator operation amount Acc and the vehicle speed V, and calculate the traveling power Pd* needed to travel by multiplying the set traveling torque Td* by the rotation speed Nd of the drive shaft 36 (the rotation speed Nm2 of the motor MG2). Subsequently, the HVECU 70 calculates the target power Pe* of the engine 22 by subtracting the charge/discharge request power Pb* of the battery 50 (a positive value when discharging from the battery 50) from the traveling power Pd*, and sets the target engine speed Ne* and the target torque Te* as target operating points of the engine 22 such that the calculated target power Pe* is output from the engine 22. In the embodiment, the target torque Te* and the target engine speed Ne* of the engine 22 are set based on the target power Pe* of the engine 22 and the operation line for efficiently operating the engine 22. FIG. 2 is a view illustrating an example of the operation line of the engine 22 and a mode of setting the target engine speed Ne* and the target torque Te*. The setting of the target torque Te* and the target engine speed Ne of the engine 22 is performed by setting the engine speed Ne1 and the torque Tel at the intersection of a curve with a constant target power Pe* of the engine 22 and the operation line of the engine 22 to the target engine speed Ne* and the target torque Te*.

Next, the HVECU 70 sets the torque command Tm1* of the motor MG1 such that the engine speed Ne of the engine 22 is the target engine speed Ne* within the range of the input/output limits Win and Wout of the battery 50, and sets the torque command Tm2* of the motor MG2 based on the traveling torque Td* and the torque command Tm1* of the motor MG1 such that the traveling torque Td* (traveling power Pd*) is output to the drive shaft 36. Then, the HVECU 70 transmits the target engine speed Ne* and target torque Te* of the engine 22 to the engine ECU 24, and transmits torque commands Tm1* and Tm2* of the motors MG1 and MG2 to the motor ECU 40. When the engine ECU 24 receives the target engine speed Ne* and the target torque Te * of the engine 22, the engine ECU 24 controls the operation of the engine 22 (intake air amount control, fuel injection control, ignition control, and the like) such that the engine 22 is operated based on the target engine speed Ne* and the target torque Te*. When motor ECU 40 receives torque commands Tm1*, Tm2 * of motors MG1, MG2, switching control of switching elements of inverters 41,42 is performed such that motors MG1, MG2 are driven by torque commands Tm1*, Tm2*.

When the accelerator is not operated in the HV travel mode, the HVECU 70 sets the traveling torque Td * (basically a negative value) based on the vehicle speed V, and sets the torque commands Tm1*, Tm2* of the motors, MG1, MG2 such that the traveling torque Td* is output to the drive shaft 36 within the range of the input/output limits Win and Wout of the battery 50 by fuel cut of the engine 22, motoring of the engine 22 by the motor MG1, and regenerative driving of the motor MG2, or by autonomous operation of the engine 22 and regenerative driving of the motor MG2. Then, the HVECU 70 transmits the fuel cut command or the autonomous operation command of the engine 22 to the engine ECU 24, and transmits torque commands Tm1* and Tm2* of the motors MG1 and MG2 to the motor ECU 40. When the engine ECU 24 receives the fuel cut command, the engine ECU 24 stops the fuel injection control and the ignition control of the engine 22, and when the engine ECU 24 receives the autonomous operation command, the engine ECU 24 controls the operation of the engine 22 such that the engine 22 is autonomously operated. The control of the inverters 41, 42 by the motor ECU 40 has been described above.

In the EV travel mode, the HVECU 70 sets the traveling torque Td * based on the accelerator operation amount Acc and the vehicle speed V, sets the torque command Tm1* of the motor MG1 to a value of zero (0), sets the torque command Tm2* of the motor MG2 such that the traveling torque Td* is output to the drive shaft 36 within the range of the input/output limits Win and Wout of the battery 50, and transmits torque commands Tm1*, Tm2* of motors MG1, MG2 to motor ECU 40. The control of the inverters 41, 42 by the motor ECU 40 has been described above.

Further, in the hybrid vehicle 20 of the embodiment, in a case where a filter regeneration condition for regenerating the PM filter 25f is satisfied in the HV travel mode, when the accelerator is not operated and the fuel cut of the engine 22 (and motoring of the engine 22 by the motor MG1) is performed, air (oxygen) is supplied to the PM filter 25f and the particulate matter deposited on the PM filter 25f burns. In this way, the PM filter 25f is regenerated. Here, as the filter regeneration condition, a condition in which the deposition amount Qpm of PM is equal to or higher than the threshold value Qpmref and the filter temperature Tf of the PM filter 25f is equal to or higher than the threshold value Tfref is used. The threshold value Qpmref is a threshold value for determining whether or not the regeneration of the PM filter 25f is needed. For example, 3 g/L, 4 g/L, 5 g/L, or the like is used. The threshold value Tfref is a threshold value for determining whether or not the filter temperature Tf has reached a reproducible temperature suitable for regeneration of the PM filter 25f. For example, 580° C., 600° C., 620° C., or the like is used.

Next, the operation of the hybrid vehicle 20 of the embodiment configured as described above, particularly the operation at the time of setting the charge/discharge request power Pb* of a battery 50 will be described. FIG. 3 is a flowchart showing an example of a charge/discharge request power routine executed by a hybrid vehicle electronic control unit (HVECU) 70. The routine is repeatedly executed when the accelerator is operated in the HV travel mode.

When the charge/discharge request power setting routine of FIG. 3 is executed, the HVECU 70 first inputs a coolant temperature Tw of the engine 22, a deposition amount Qpm of PM, a filter temperature Tf, a power storage ratio (state of charge) SOC of the battery 50, a traveling power Pd*, and the like (step S100). Here, a value detected by the coolant temperature sensor 23b is input as the coolant temperature Tw of the engine 22 from an engine ECU 24 by communication. Values calculated by the engine ECU 24 is input as the deposition amount Qpm of PM and the filter temperature Tf by communication. A value calculated by the battery ECU 52 are input as the power storage ratio SOC of the battery 50 by communication. A value set based on the accelerator operation amount Acc and the vehicle speed V as described above is input as the traveling power Pd*.

When data is input as described above, determination is made whether or not a filter temperature rise condition is satisfied based on the input deposition amount Qpm of PM and the filter temperature Tf (step S110). Here, as the filter temperature rise condition, a condition in which the deposition amount Qpm of PM is equal to or higher than the threshold value Qpmref and the filter temperature Tf is less than the threshold value Tfref is used.

When the filter temperature rise condition is not satisfied in S110 (including when the above filter regeneration condition is satisfied), the charge/discharge request power Pb* is set based on the power storage ratio SOC of the battery 50 (step S120). Then the routine ends. In the processing of step S120, the relationship between the charge/discharge request power Pb*and the power storage ratio SOC of the battery 50 is predetermined and stored as a map for a first charge/discharge request power setting in a ROM (not illustrated), and when the power storage ratio SOC is given, the corresponding charge/discharge request power Pb* is derived from the map and set.

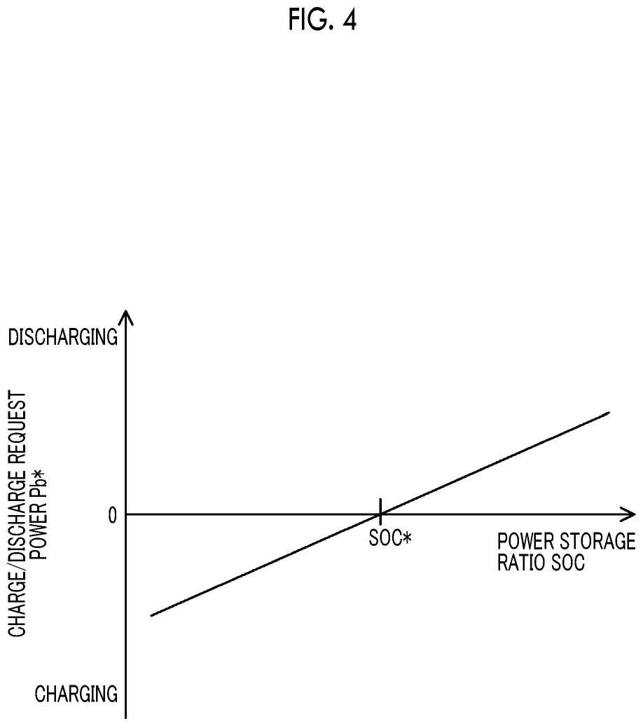

FIG. 4 is a view illustrating an example of the map for the first charge/discharge request power setting. As illustrated in the figure, the charge/discharge request power Pb* of the battery 50 is set to zero (0) when the power storage ratio SOC of the battery 50 is a target power storage ratio SOC* (for example, 50% or 55%, 60%), is set to decrease (increase in terms of the absolute value) as the power storage ratio SOC decreases in a negative range (range in which the battery 50 is charged), when the power storage ratio SOC is smaller than the target power storage ratio SOC*, and is set to increase as the power storage ratio SOC increase in a positive range, when the power storage ratio SOC is larger than the target power storage ratio SOC*. By setting the charge/discharge request power Pb* of the battery 50 as described above, the power storage ratio SOC of the battery 50 can be set close to the target power storage ratio SOC*.

When the filter temperature rise condition is not satisfied in S110, the charge/discharge request power Pb* of the battery 50 is set based on the coolant temperature Tw of the engine 22 and the traveling power Pd* (step S130). Then the routine ends.

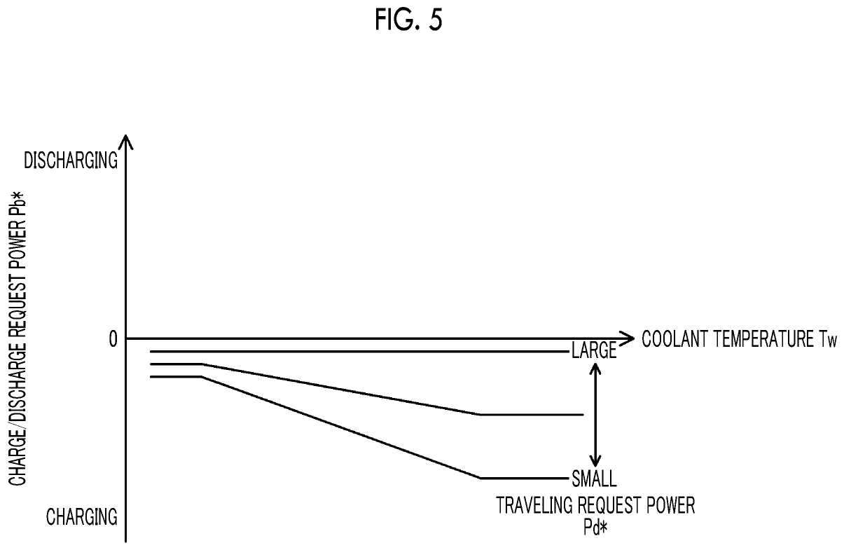

In the processing of step S130, the relationship between the traveling power Pd* and the coolant temperature Tw of the engine 22 and the charge/discharge request power Pb* of the battery 50 is predetermined and stored as a map for a second charge/discharge request power setting in the ROM (not illustrated), and when the traveling power Pd* and the coolant temperature Tw of the engine 22 and is given, the corresponding charge/discharge request power Pb* is derived from the map and set. FIG. 5 is a view illustrating an example of the map for the second charge/discharge request power setting. As illustrated in the figure, the charge/discharge request power Pb* of the battery 50 is set to increase as the coolant temperature Tw of the engine 22 decreases (increases in terms of the absolute value) within the negative range, and set to increase as the traveling power Pd* increases (decreases in terms of the absolute value).

When the charge/discharge request power Pb* of the battery 50 is set in the negative range, the target power Pe* of the engine 22 is larger than the traveling power Pd*. In this case, traveling is performed by the traveling power Pd* output to the drive shaft 36, and at the same time, battery 50 is charged with the difference power between the target power Pe* of the engine 22 and the traveling power Pd*. Accordingly, the temperature rise of the PM filter 25f can be promoted as compared to when the target power Pe* of the engine 22 is equal to or less than the traveling power Pd*. Hereinafter, a control process, which is performed by setting the charge/discharge request power Pb* of the battery 50 within the negative range, setting the target power Pe* of the engine 22 using the charge/discharge request power Pb*, and controlling the engine 22 and the motors MG1, MG2 to travel based on the traveling torque Td* (traveling power Pd*) with output of the target power Pe* and power generation by the motor MG1, is referred to as “filter temperature rising control”. Meanwhile, as the coolant temperature Tw of the engine 22 is lower, the fuel is less likely to vaporize, and the particulate matter flowing into the PM filter 25f tends to increase. In addition, as the power from the engine 22 is greater, more fuel is supplied to the engine 22, and the particulate matter flowing into the PM filter 25f tends to increase. Considering the above, in the embodiment, the charge/discharge request power Pb* is set according to the tendency of FIG. 5 when the filter temperature rising control is performed. Therefore, as the coolant temperature Tw of the engine 22 is lower and the traveling power Pd* becomes larger, the increase in the target power Pe* of the engine 22 with respect to the traveling power Pd* can be reduced. As a result, it is possible to suppress an excessive increase in the amount of particulate matter flowing into the PM filter 25f.

As described above, in the embodiment, when the accelerator is not operated in the HV travel mode, the engine 22 and the motors MG1, MG2 are controlled to travel by fuel cut of the engine 22, motoring of the engine 22 by the motor MG, and regenerative driving of the motor MG2, or based on the traveling torque Td* by the autonomous operation of the engine 22 and the regenerative drive of the motor MG2. That is, when the accelerator is not operated in the HV traveling mode, the filter temperature rising control is not executed. In a case where the filter temperature rising control is performed when the accelerator is not operated in the HV travel mode, a certain amount of power is output from the engine 22 and the battery 50 is charged, which may result in uncomfortable feeling of a driver. On the other hand, in the embodiment, the filter temperature rising control is not performed when the accelerator is not operated in the HV travel mode. In this way, it is possible to suppress the sense of discomfort which the driver may feel.

In the hybrid vehicle 20 of the embodiment described above, when the filter temperature rise condition is satisfied when the accelerator is operated, the charge/discharge request power Pb* of the battery 50 is set to increase as the coolant temperature Tw decreases (decrease in terms of the absolute value) and increase as the traveling power Pd* increases (decreases in terms of the absolute value) in the negative range, and the target power Pe* of the engine 22 is set by subtracting the charge/discharge request power Pb* of the battery 50 from the traveling power Pd*. Therefore, as the coolant temperature Tw of the engine 22 is lower and the traveling power Pd* is larger, the increase in the target power Pe* of the engine 22 with respect to the traveling power Pd* can be reduced. As a result, it is possible to suppress an excessive increase in the amount of particulate matter flowing into the PM filter 25f.

In the hybrid vehicle 20 of the embodiment, when the filter temperature rise condition is satisfied, the charge/discharge request power Pb* of the battery 50 is set based on the traveling power Pd* and the coolant temperature Tw of the engine 22. However, the charge/discharge request power Pb* may be set based on any one of the traveling power Pd* and the coolant temperature Tw of the engine 22.

In the hybrid vehicle 20 of the embodiment, when the filter temperature rise condition is satisfied, the filter temperature rising control is performed when the accelerator is operated, and the filter temperature rising control is not performed when the accelerator is not operated. However, when the filter temperature rise condition is satisfied, the filter temperature rising control may be performed regardless of whether or not the accelerator is operated.

Although not described in the hybrid vehicle 20 of the embodiment, it may be that the charge/discharge request power Pb* of the battery 50 is set in step S120 or step S130 and then a processing for arbitration with other requirements is performed to set the final charge/discharge request power Pb* of the battery 50. In the processing for arbitration, for example, a sufficiently small value within the negative range (large in terms of the absolute value) is set to the charge/discharge request power Pb* of the battery 50, instead of the charge/discharge request power Pb* of the battery 50 set in step S120 or step S130, when the power storage ratio SOC of the battery 50 is less than the allowable lower limit ratio Slo (for example, 30%, 35%, 40% or the like) or when the voltage Vb of the battery 50 is less than the allowable lower limit voltage Vblo. In this way, it is possible to forcibly charge the battery 50 with sufficiently large power, and suppress the excessive discharge of the battery 50.

In the hybrid vehicle 20 of the embodiment, the engine speed Ne1 and the torque Tel at the intersection of the equal power curve for the target power Pe* of the engine 22 and the operation line of the engine 22 are set to the target engine speed Ne* and the target torque Te* in the HV travel mode. However, the engine speed, which is obtained by guarding the number of revolutions Ne1 at the intersection by the allowable lower limit engine speed Nemin may be set to the target engine speed Ne*, and the same time the torque, which is obtained by diving the target power Pe* of the engine 22 by the target engine speed Ne*, may be set to the target torque Te*. Here, the allowable lower limit engine speed Nemin is defined as the engine speed at which the air amount per unit time of the engine 22, that is, a certain amount of exhaust gas per unit time flowing into the PM filter 25f can be secured and the driver does not hear noise when the accelerator operation amount Ace is small (when the target power Pe* of the engine 22 is small), for which 1500 rpm, 1700 rpm, 2000 rpm, or the like, is used. By setting the target torque Te* and the target engine speed Ne* of the engine 22, it is possible to secure a certain amount of exhaust gas flowing into the PM filter 25f and to promote the temperature rise of the PM filter 25f to some extent, even when the accelerator operation amount Ace is small. In addition, when the accelerator operation amount Ace is small, it is possible to suppress noise such that the driver cannot hear it.

In the hybrid vehicle 20 of the embodiment, the battery 50 is used as the power storage device. However, a capacitor may be used instead of the battery 50.

Although the hybrid vehicle 20 of the embodiment includes the engine ECU 24, the motor ECU 40, the battery ECU 52, and the HVECU 70, at least two of the ECUs may be configured as a single electronic control unit.

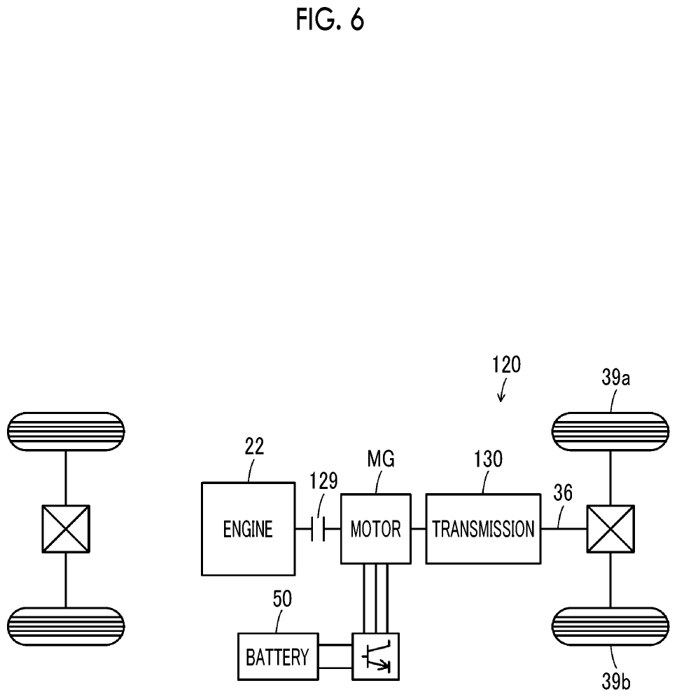

The hybrid vehicle 20 of the embodiment has the configuration in which the engine 22 and the motor MG1 are connected to the drive shaft 36 connected to the drive wheels 39a, 39b through the planetary gear 30, the motor MG2 is connected to the drive shaft 36, and the battery 50 is connected to the motors MG1 and MG2 through the power lines. However, as illustrated in a modification example in FIG. 6, a hybrid vehicle 120 may have a configuration in which a motor MG is connected to the drive shaft 36 connected to the drive wheels 39a, 39b through a transmission 130, the engine 22 is connected to the motor MG through a clutch 129, and the battery 50 may be connected to the motor MG through power lines.

The correspondence between the main elements of the embodiment and the main elements of the present disclosure described in the Summary section will be described. In the embodiment, the engine 22 corresponds to the “engine”, the motor MG1 corresponds to the “motor”, the battery 50 corresponds to the “power storage device”, and the HVECU 70, the engine ECU 24, and the motor ECU 40 correspond to the “control device”.

The correspondence between the main elements of the embodiment and the main elements of the present disclosure described in the Summary section is not construed to limit elements of the present disclosure described in the Summary section, since embodiment is an example to specifically describe the mode for carrying out the present disclosure described in the Summary. That is, the interpretation of the present disclosure described in the Summary section should be made based on the description of the section, and the embodiment is only the specific example of the present disclosure described in the Summary section.

As described above, aspects of implementing the present disclosure have been described using the embodiment. However, an applicable embodiment of the present disclosure is not limited to the above embodiment, and various modifications thereof could be made without departing from the scope of the present disclosure.

The present disclosure can be used in the manufacturing industry of hybrid vehicles.

What is claimed is:

1. A hybrid vehicle comprising:
an engine in which a filter for removing particulate matter is attached to an exhaust system;
a motor connected to an output shaft of the engine;
a power storage device that exchanges an electric power with the motor; and
a control device that performs filter temperature rising control that sets a target power of the engine within a range larger than a traveling power needed to travel and controls the engine and the motor to travel based on the traveling power with output of the target power from the engine and power generation by the motor, when temperature rise of the filter is requested, wherein
the control device is configured to set the target power based on at least one of a temperature of the engine and the traveling power, when the filter temperature rising control is performed.

2. The hybrid vehicle according to claim 1, wherein the control device is configured to set the target power to be smaller when the temperature of the engine is lower than when the temperature of the engine is higher, when the filter temperature rising control is performed.

3. The hybrid vehicle according to claim 1, wherein the control device is configured to set the target power to be smaller when the traveling power is larger than when the traveling power is smaller, when the filter temperature rising control is performed.

4. The hybrid vehicle according to claim 1, wherein the control device is configured to perform the filter temperature rising control when an accelerator is operated and not to perform the filter temperature rising control when the accelerator is not operated, when temperature rise of the filter is requested.

5. The hybrid vehicle according to claim 1, wherein the control device is configured to control the engine such that the engine revolves at a predetermined engine speed or higher, when the filter temperature rising control is performed.
